(19) United States
(12) Patent Application Publication
(10) Pub. No.: US 2013/0071728 A1
(43) Pub. Date: Mar. 21, 2013

(54) Secondary Battery

(71) Applicants: Hideyuki Shibanuma, Kasama (JP); Kouichi Kajiwara, Hitachinaka (JP)

(72) Inventors: Hideyuki Shibanuma, Kasama (JP); Kouichi Kajiwara, Hitachinaka (JP)

(21) Appl. No.: 13/642,305

(22) PCT Filed: Feb. 23, 2011
(86) PCT No.: PCT/JP2011/053976

§ 371 Date: Nov. 30, 2012

(30) Foreign Application Priority Data
Apr. 28, 2010 (JP) 2010-103599

(51) Int. Cl. H01M 2/08

(52) U.S. Cl. CPC H01M 2/08
USPC 429/179

(57) ABSTRACT

A highly-reliable secondary battery is provided. The secondary battery is configured as below. A battery lid 1 is formed with a cylindrical projection 1a projecting toward an insulating member 3. The cylindrical projection 1a is secured to the insulating member 3 (a caulking portion 1A) by caulking so as to be bent outwardly at a position inside a projecting insertion hole 3b formed in the insulating member 3. A tip portion of a connecting pin 5 inserted through the pin insertion hole is caulked (a caulking portion 5d) to establish conduction between the connecting pin 5 and an external terminal 4 and to secure the external terminal 4, the insulating member 3, a gasket 2 and the connecting pin 5 to the battery lid 1. Thus, a terminal portion 15 does not turn.

### TECHNICAL FIELD

The present invention generally relates to secondary batteries and more particularly to a secondary battery that has a closed-bottom metallic battery can to house a power generating element, a metallic battery lid to seal the opening of the battery can, and a terminal portion installed on the battery lid.

### BACKGROUND ART

Along with the social trends of preservation of the global environment, it has recently become imperative to put into practical use and spread secondary batteries for driving vehicles such as hybrid vehicles and electric vehicles. The structure of a secondary battery for driving a vehicle is widely known in the art as follows. The power generating element includes a power generating element group in which a positive plate and a negative plate are arranged via a separator, and an electrolyte for infiltrating the power generating element group. A closed-bottom battery can, which is made of metal or resin, houses the power generating element therein and a battery lid seals the opening of the battery can. The secondary battery has terminal portions electrically connected to both electrodes of the power generating element group.

Most of the secondary batteries put into practice so far have a columnar external shape. However, it is necessary, in the secondary battery for driving a vehicle, to collect several tens to one hundred or more of secondary batteries to form a battery pack and mount it on one vehicle so as to improve battery output and capacity. view of this, also intensive studies on rectangular secondary batteries for practical use have been performed so as to improve packaging density (volumetric density) and radiation characteristics.

The secondary battery as mentioned above is configured as below for example. The secondary battery has a metallic battery can. The battery can is formed by a deep drawing method such that the dimension of the depth thereof is greater than that of the short side of an opening thereof. The battery can houses the power generating element group and the electrolyte as described. The power generating element group is such that positive and negative plates having current collector foil are wound or laminated and have sections at which positive and negative material mixtures are uncoated at both ends thereof. The positive and negative plates are joined to the associated uncoated sections at respective joint potions by ultrasonic waves or the like. A battery lid is disposed at the opening of the battery can. A positive terminal and a negative terminal for connection with the outside are secured to the battery lid via respective seal members (e.g. gaskets) adapted to avoid electrical contact with the battery lid and to keep the air tight in the battery. The opening of the battery can is sealed by the battery lid by laser (beam) welding or the like. The electrolyte is poured into the battery can from a liquid pouring opening and then the liquid pouring opening is hermetically sealed by a liquid pouring plug by laser welding or the like. (See e.g. JP-2009-129719-A)

A terminal portion includes a plate-like external terminal; an insulating member electrically insulating the electric lid and the external terminal from each other; and pin-like conductive members electrically connected to the respective positive and negative plates of the power generating element group. The terminal portion is secured to the battery lid by caulking. The conductive member is caulked at a through-hole formed in the battery lid so as to secure one side end of the insulating member. This establishes conduction between the external terminal and the conductive member and prevents the turning of the terminal portion. (See e.g. JP-2009-301874-A)

### SUMMARY OF THE INVENTION

### Problem to be Solved by the Invention

In the conventional structure of the terminal portion, however, the vicinity of the caulking portion of the insulating member is subjected to compressed force when the conductive member is caulked. The other side end portion apart from the caulking portion of the insulating member loosens accordingly, which reduces the effect of preventing turning. Consequently, the terminal portion is liable to turn around the caulking portion. The turn of the terminal portion poses problems in that the terminal seal portion lowers in seal performance and the current collector foils of the positive and negative plates that constitute the power generating element group inside the battery suffer damage.

The present invention has been made in view of the above situations and aims to provide a highly-reliable secondary battery.

### Means for Solving the Problem

To solve the above problem, the present invention is characterized by including: a closed-bottom metallic battery can for housing a power generating element; a metallic battery lid for sealing an opening of the battery can, the battery lid being formed with a through-hole for leading out a terminal; and a terminal portion installed on the battery lid; the terminal portion including a plate-like external terminal formed with a through-hole, an insulating member for electrically insulating the battery lid and the external terminal from each other, the insulating member being formed with a through-hole, and a pin-like conductive member electrically connected to an electrode plate constituting the power generating element, the pin-like conductive member being inserted through, in the following order, respective through-holes formed in the battery lid, the insulating member and the external terminal; in that the battery lid is formed with a first projection projecting toward the insulating member, with the first projection being fixed to a concave portion or a hole portion by caulking, the concave portion or the hole portion being formed in the insulating member in association with the position where the first projection is formed; and in that a tip portion of the conductive member inserted through the through-hole is caulked to establish conduction between the conductive member and the external terminal and to secure the external terminal, the insulating member and the conductive member to the battery lid.

In the present invention, the tip portion of the first projection may have a cylindrical or polygonal-tubular shape, and may be secured to the insulating member by caulking so as to be bent outwardly at the concave portion or the hole portion formed in the insulating member. To prevent the turning of the terminal portion, the battery lid may be formed with a second projection projecting toward the insulating member at a position between the through-hole and the first projection, with the second projection being fitted to a concave portion or a hole portion, the concave portion or the hole portion being formed in the insulating member in association with the position where the second projection is formed. In this case, the battery lid may be formed with a plurality of the second projections and the insulating member may be formed with concave portions or hole portions at respective positions corresponding to the second projections. Preferably, the second projection is formed at a position apart from an imaginary line connecting the center of the through-hole formed in the battery lid and the center of the first projection, with the through-hole and the first projection being formed in and at the battery lid. Further, if external force is exerted on the external terminal, in order the external terminal to be deformed to absorb the external force, it is desirable that the external terminal have a constricted portion reduced in width in a width direction. Preferably, the terminal portion further has an insulating seal member for sealing a gap defined between the battery lid and the conductive member at the through-hole formed in the battery lid.

### Effect of the Invention

According to the present invention, the battery lid is formed with the first projection and the first projection is secured by caulking with the concave portion or the hole portion formed in the insulating member. Therefore, when the tip portion of the conductive member is caulked, the insulating member will not loosen. Thus, the present invention can solve the above-mentioned problem and provide an effect of attaining a highly-reliable secondary battery.

### BRIEF DESCRIPTION OF THE DRAWINGS

FIG. 1 is an exploded perspective view of a secondary battery of an embodiment to which the present invention can be applied.

FIG. 2 is a cross-sectional view of a negative terminal portion of the secondary battery of the present embodiment.

FIG. 3 is an exploded perspective view of the negative terminal portion.

FIG. 4 is a top view on one side of a battery lid.

FIG. 5 shows an insulating member of the negative terminal portion, (A) being a top view and (B) being a rear view.

FIG. 6 is a top view of an external terminal received in the negative terminal portion.

### MODE FOR CARRYING OUT THE INVENTION

An embodiment of the present invention, which is applied to a square lithium-ion secondary battery for hybrid vehicles, will hereinafter be described with reference to the drawings.

### (Configuration)

### <Overall Configuration of the Battery>

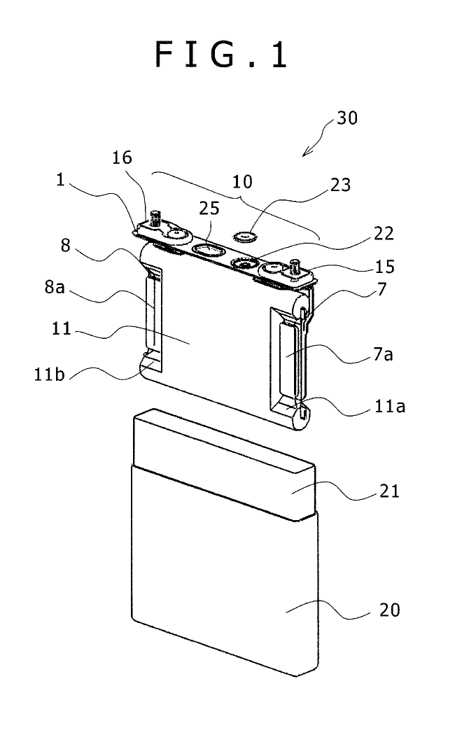

As shown in FIG. 1, a secondary battery 30 of the present embodiment includes a power generating element group (an electrode group) 11 as a part of a power generating element and closed-bottom metallic (an aluminum alloy-made, in this example) battery can 20 with the power generating element group 11 housed in the closed-bottom metallic battery can 20 while being saturated with a non-aqueous electrolyte not shown. The battery can 20 has a square shape (a rectangular shape) with rounded corners and has the depth dimension greater than the short side of an opening portion thereof, which is formed by a deep drawing method. To prevent electric contact between the power generating element group 11 and the battery can 20, a resin-made (polypropylene-made, in this example) insulating case 21 is interposed therebetween. In addition, the insulating case 21 is slightly smaller than the inside measure of the battery can 20. Incidentally, the secondary battery 30 has neutrality, that is, the electric can 20 and the battery lid 1 have no polarity.

The power generating element group 11 of the present embodiment has a flat wound structure in which a separator, a negative plate, a separator and a positive plate are stacked in this order, wound and crushed in a flattened manner. The separator is wound by several turns (no shaft core for weight saving) at a winding-start end portion. In addition, the separator is wound by several turns also at a winding-termination end portion. To prevent the release of the winding, the winding-termination end portion of the separator is retained by tape whose one surface has previously been applied with an adhesive.

The negative plate is such that a negative-electrode active material mixture containing a carbon material such as graphite which can store and release lithium ions is painted (coated) as a negative-electrode active material on both surfaces of a copper alloy gold foil (a negative collector) in a generally even and uniform manner. In addition, the negative plate is formed on both the sides thereof and on one longitudinal side thereof with a negative uncoated section 11a on which a negative-electrode active material mixture is not coated. On the other side, the positive plate is such that a positive-electrode active material mixture containing e.g. lithium-contained transition metal multiple oxide such as lithium manganese oxide is painted as a positive-electrode active material on both surfaces of an aluminum alloy foil (a positive collector) in a generally even and uniform manner. The, positive plate is formed on both the sides and one longitudinal side thereof with a positive uncoated section lib on which the positive-electrode material mixture is not coated. The separator is composed of a micro-porous sheet material through which lithium ions can pass. In the present embodiment, a polyethylene sheet having a thickness of several tens μm is used as the separator.

The negative uncoated section 11a and the positive uncoated section 11b are arranged opposite to each other with respect to the power generating element group 11. A central portion of each of the negative uncoated section 11a and the positive uncoated section 11b is pressed by a jig to be bent so as to be concentrated toward a main surface (which is a surface having the largest area and is an imaginary surface passing through the center of the flat wound structure) of the power generating element group. The concentrated negative uncoated sections 11a and positive uncoated sections lib form a negative joint section 7a and a positive joint section 8a, respectively. At these locations, the negative uncoated section 11a and a negative connection plate 7 made of a copper alloy are integrally pressed by a jig and ultrasonic-welded so that one side of the negative connection plate 7 and the negative plate forming the power generating element group 11 are electrically and mechanically joined together. In addition, the positive uncoated section 11b and the positive joint portion 8a made of an aluminum alloy are integrally pressed by a jig and ultrasonic-welded so that one side of the positive joint portion 8 and the positive plate forming the power generating element group 11 are electrically and mechanically joined together.

A battery lid assembly 10 is disposed on an upper portion of the power generating element group 11. The battery lid assembly 10 includes a plate-like battery lid 1 made of an aluminum alloy; a negative terminal portion 15 electrically connected as a part of a terminal portion to the other side of the negative connection plate 7; a positive terminal portion 16 electrically connected as a part of a terminal portion to the other side of the positive connection plate 8; a liquid pouring plug 23 sealing a liquid pouring opening 22 formed in the battery lid 1 and used to pour the electrolyte; and a cleaving valve 25 cleaved at a given pressure when pressure inside the battery increases.

The battery lid 1 is formed of a flat plate having a size equal to that of the opening of the battery can 20 (rounded so as to fit the battery can 20). In addition, the battery lid 1 is formed with four through-holes: in the order from the right in FIG. 4, a pin insertion hole is as a through-hole for leading out the negative electrode (see FIG. 4, a round hole in this example), a liquid pouring opening 22, an oblong through-hole for attachment of the cleaving valve, and a pin insertion hole for leading out the positive electrode. The through-hole for attachment of the cleaving valve is sealed by laser (beam) welding a plate-like member (the cleaving valve 25) formed with a fragile portion such as a groove or the like at its central portion. Incidentally, the pin insertion hole for leading out the negative electrode (and for leading out the positive electrode) will be described later. The battery lid 1 is joined to the battery can 20 by laser welding in a manner that the contour of the battery lid 1 conforms to the battery can 20 so as to seal the opening of the battery can 20.

The power generating element group 11 is saturated with the electrolyte poured through the liquid pouring opening 22. The power generating element group 11 and the electrolyte which constitute an power generating element are housed inside the battery can 20 and are sealed by the battery lid assembly 10. Incidentally, the electrolyte solution can be used, for example, in which lithium salt such as lithium fluorophosphates (LiPF₆ or the like is dissolved at an approximate rate of 1 mol/liter in a carbonate ester-based organic solvent such as, for example, ethylene carbonate or the like.

### <Structure of the Terminal Portion>

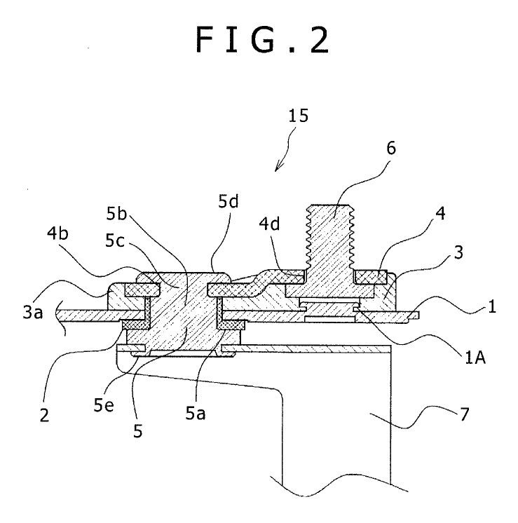

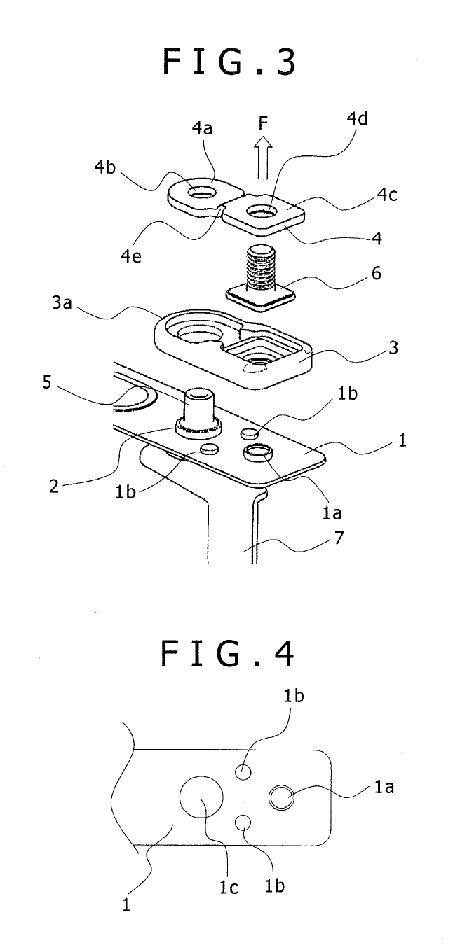

As shown in FIGS. 2 and 3, the negative terminal portion 15 includes a connection pin 5 serving as a pin-like conductive member shaped like a rivet; a gasket 2 serving as an insulating seal member for sealing a gap defined by the battery lid 1 and the connection pin 5 at the pin insertion hole 1c formed in the battery gap 1; a resinous insulating member 3; a square head bolt 6 used to secure a bus bar (a connection member connecting electric cells together) not shown; and a negative external terminal 4 as a part of a plate-like external terminal.

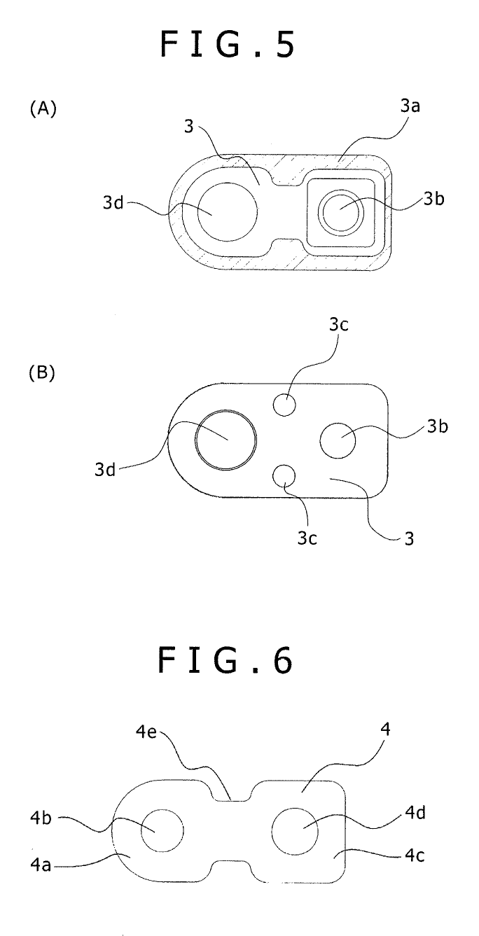

The connection pin 5 is made of a copper alloy (the positive electrode is made of an aluminum alloy) and includes a first shaft portion 5b (see FIG. 2), a circular flange portion 5a, a cylindrical portion (in FIG. 2, a shape after caulking is shown as a caulking portion 5e and not shown in FIG. 3), a second shaft portion 5c, and a cylindrical portion (in FIG. 2 a shape of a caulking portion 5d after caulking is shown and in FIG. 3 a shape before the caulking is shown). The first shaft portion 5b is inserted through the pin insertion hole 1c. The circular flange portion 5a is formed below the first shaft portion 5b. The former cylindrical portion is formed below the flange portion 5a and used to caulking-secure (by processing) the other side end portion of the negative connection plate 7 formed with a round hole. The second shaft portion 5c is a portion passing through a pin insertion hole 4b as a through-hole formed in the negative external terminal 4 and has a diameter smaller than that of the first shaft portion 5b. The latter cylindrical portion is formed above the second shaft portion 5c and is used to caulking-secure the insulating member 3 and the negative external terminal 4 in this order to the battery lid 1 via the pin insertion hole 3d (see FIG. 5) as a through-hole formed in the insulating member 3 and via the pin insertion hole 4b formed in the negative external terminal 4. Incidentally, the outside diameter of the cylindrical portion is set equal to the diameter of the second shaft portion 5c.

The cylindrical portion forming a caulking portion 5e of the connection pin 5 is inserted through the round hole formed on the other side end portion of the negative connection plate 7 and then caulked (see. FIG. 2). In this way, the negative connection plate 7 and the connection pin 5 are electrically and mechanically connected to each other in such a manner as to be electrically insulated from the battery lid 1 via the gasket 2 (see FIG. 3).

The gasket 2 has a tubular portion (through which the first shaft portion 5b of the connection pin 5 is inserted) and a circular flange portion formed below the tubular portion. Examples of a material used for the gasket 2 include an insulating resin such as polyphenylene sulfide (PPS), polybutylene terephthalate (PBT) and perfluoroalkoxy fluorine (PFA).

A circumferential portion of the pin insertion hole 1c on the back side (on the side close to the battery) of the battery lid 1 is slightly thinned (according to the size of the flange portion of the gasket 2) (see FIG. 2). The flange portion of the gasket 2 is on one surface side (on the upper surface side of the flange portion shown in FIG. 2) in contact with the thinned back surface of the battery lid 1. Thus, the gasket 2 seals the gap defined between the battery lid 1 and the connection pin 5 at the pin insertion hole 1c formed in the battery lid.

As shown in FIG. 4, a cylindrical projection 1a as a first projection and two circular projections 1b as second projections are located in this order from the right of FIG. 4, by the so-called halftone, so as to project at a portion closer to the end portion than a location formed with the pin insertion hole 1c of the battery lid 1. The two circular projections 1b are adjacent to each other in the direction intersecting the longitudinal direction of the lid 1. The cylindrical projection 1a is used to secure the insulating member 3. The circular projections 1b are used to lock the turn of the insulating member 3. The cylindrical projection 1a has a tip portion shaped like a cylinder. Incidentally, in the present embodiment, the circular projections 1b are formed at respective positions away from an imaginary straight line connecting the center of the pin insertion hole 1c with the center of the cylindrical projection 1a (so that the circumferential portion of the circular projection 1b may not contact or cross the imaginary straight line). In addition, the circular projections 1b are formed so that the above-mentioned imaginary straight line and an imaginary straight line connecting the centers of the two circular projections 1b together may cross perpendicularly to each other.

Because of being located outside the battery, to ensure strength, the insulating member 3 is formed of that in which “rigid plastic” defined in JIS K6900 Plastic-Vocabulary is mixed with fibrous glass (FG). As shown in FIG. 5(A), the insulating member 3 has a generally rectangular shape (whose one side is arc-like) as a whole so that an insulating protective portion 3a may cover the circumferential portion of the negative external terminal 4. The insulating member 3 is internally formed, by resin molding, with a plurality of spaces to secure or receive the above-mentioned members therein (see FIG. 3). Specifically, the spaces thus formed include: a square-shaped head receiving space for receiving the head of the square head bolt 6 without play (without allowance as much as possible) (on the right side of the insulating member 3 shown in FIG. 3); a projection insertion hole 3b as a concave portion or a hole portion formed immediately below the head receiving space and receiving the above-mentioned cylindrical projection 1a; a circular receiving space formed adjacently to the head receiving space (on the left side of the insulating member 3 shown in FIG. 3) and receiving the end portion of the tubular portion of the gasket 2 and the end side of the first shaft portion 5b of the connection pin 5; and an external terminal receiving space formed across above the head receiving space and immediately above the circular receiving space and receiving the negative external terminal 4 (see FIG. 2). As shown in FIG. 5(B), circular concave portions 3c are formed on the bottom side of the insulating member 3 so as to be fitted to the corresponding circular projections lb provided on the battery lid 1 to project therefrom.

The square head bolt 6 used in the present embodiment is made of nickel-plated steel. The square head bolt 6 has a head composed of a relatively thin square plate-like member and a shaft portion formed with an external screw thread.

As shown in FIG. 6, the negative external terminal 4 is formed by connecting two portions: a rectangular portion 4c and a circular portion 4a. The rectangular portion 4c is generally square and formed at its center with a bolt insertion hole 4d adapted to receive the shaft portion of the square head bolt 6 inserted therethrough. The circular portion 4a is generally circular and is formed with a pin insertion hole 4b at its center. A constricted portion 4e smaller in width than the rectangular portion 4c and the circular portion 4e is formed at a portion where the rectangular portion 4c and the circular portion 4a are connected to each other. The rectangular portion 4c and the circular portion 4a have a step therebetween in a height direction (a vertical direction shown in FIG. 3) at the constricted portion 4e, the step nearly corresponding to the thickness of the head of the square head bolt 6 (see also FIG. 1). With this step, the rectangular portion 4c of the negative external terminal 4 is exposed upward from the insulating protective portion 3a of the insulating member 3. Thus, the problem of poor contact can be eliminated when electric cells are connected together by means of the bus bar mentioned above.

As shown in FIG. 3, with the insulating member 3, the concave portions 3c formed on the bottom side thereof are engaged with the corresponding circular projections lb provided on the battery lid 1 to project therefrom, and the projection inserting hole 3b is inserted therethrough with the cylindrical projection 1b provided on the battery lid 1 to project therefrom. The cylindrical projection 1a is outwardly bent approximately 90° by caulking (processing) at its tip portion, so that the insulating member 3 is secured to the battery lid 1 (see the caulking portion 1A in FIG. 2). The head of the square head bolt 6 is received in the head receiving space. Incidentally, the insulating portion 3 is formed with a space to prevent the contact between the head of the square head bolt 6 and the caulked cylindrical projection la, i.e., the caulking portion 1A. However, an insulating material may be interposed in the space as necessary.

As shown in FIG. 2, the other side end portion of the negative connection plate 7 is caulked with the tubular portion formed on the lower side the flange portion 5a of the connection pin 5 (see the caulking portion 5e in FIG. 2) and is secured to the connection pin 5. The first shaft portion 5b of the connection pin 5 and the tubular portion of the gasket 2 are inserted through the pin insertion hole 1c of the battery lid 1. In this way, the flange portion 5a of the connection pin 5 and the flange portion of the gasket 2 are disposed inside the battery can 20 (on the lower side of the battery lid 1).

The tip of the tubular portion of the gasket 2 and the tip side of the first shaft portion 5b of the connection pin 5 are inserted through and received in the circular receiving space of the insulating member 3. Technically, the gap defined between the tip side of the first shaft portion 5b of the connection pin 5 and the circular receiving space of the insulating member 3 is sealed by the tip of the tubular portion of the gasket 2. The second shaft portion 5c of the connection pin 5 is inserted thorough the pin insertion hole 4b of the negative external terminal 4 (see FIG. 2). On the other hand, the shaft portion of the square head bolt 6 is inserted through the bolt insertion hole 4d of the negative external terminal 4 (see FIG. 3). The external terminal 4 is in contact with the head (the upper surface) of the square head bolt 6 and with the head side of the shaft portion.

As shown in FIG. 2, the tubular portion of the connection pin 5 is bent outwardly approximately 90° by caulking (processing) (see the caulking portion 5d in FIG. 2). Thus, the caulking portion 5d of the connection pin 5 establishes conduction between the connection pin 5 and the negative external terminal 4. In addition, the connection pin 5, the gasket 2, the insulating member 3, the square head bolt 6 and the negative external terminal 4 are secured to the battery lid 1 in such a manner as to prevent electrical short with the battery lid 1. The other side end portion of the negative connection plate 7 is caulked at the caulking portion 5e of the connection pin 5. In addition, the one side end portion of the negative connection plate 7 is welded to the negative joint portion 7a as described above. Thus, also the power generating element group 11 is supported at the caulking portion 5d of the connection pin 5 by the battery lid 1 via the negative connection plate 7.

Incidentally, the positive terminal portion 16 basically has the same structure as that of the negative terminal portion 15 described above. However, the positive terminal portion 16 is different from the negative terminal portion 15 in the following points. First, the positive terminal portion 16 is disposed symmetrically to the negative terminal portion 15. The connection pin 5 and the positive external terminal thus used are made of an aluminum alloy. Further, also the positive connection plate 8 thus used is made of an aluminum alloy because of the relationship with a metal material forming the positive terminal portion 16.

### (Assembly Procedure for the Battery)

An assembly procedure for the secondary battery of the present embodiment is next described briefly. Needless to say, the present invention is not limited to the assembly method exemplified below.

The negative and positive uncoated sections 11a, 11b of the power generating element group 11 and the negative and positive connection plates 7, 8 are joined at the corresponding joint portions 7a, 8a by ultrasonic welding to the previously manufactured battery lid assembly 10 (as shown in FIG. 3, in this state both the connection plates 7, 8 are caulked with the connection pins 5). In addition, also the one side end portions of the connection plates 7, 8 are simultaneously joined. These are next inserted into the battery can 20 through the insulating case 21. The battery can 20 and the battery lid 1 are laser (beam) welded to seal the battery can 20. Thereafter, the electrolyte is poured from the liquid pouring opening 22 into the battery can 20 and the liquid pouring plug 23 is hermetically sealed by laser welding.

The battery lid assembly 10 can be manufacture as below. The circular projections 1b provided on the battery lid 1 to project therefrom are fitted to the corresponding concave portions 3c formed on the bottom side of the insulating member 3. In addition, the cylindrical projection 1a provided on the battery lid 1 to project therefrom is inserted through the projection insertion hole 3b. The tip portion of the cylindrical projection 1a is bent outwardly approximately 90° by caulking (to form the caulking portion 1A shown in FIG. 2). Thus, the insulating member 3 is temporarily secured to the battery lid 1. The gasket 2 is next inserted through the first shaft 5b of the connection pin 5 from above and is inserted through the pin insertion hole 1c of the battery lid 1 from the lower side. Further, the insulating member 3 is inserted, from the upper side of the battery lid 1, through the gasket 2 having been inserted through the connection pin 5. Next, the negative external terminal 4 is inserted through the second shaft portion 5c of the connection pin 5 with the square head bolt 6 held between the insulating member 3 and the negative external terminal 4. Lastly, the tubular portion of the connection pin 5 is caulked, thereby completing the battery lid assembly 10. Thereafter, as a matter of course, initial charge and inspection are performed. Incidentally, the description of a method of mounting the cleaving valve 25 is omitted because of public knowledge.

### (Function and Effect)

A description is next given of the function, effect and so on of the secondary battery 30 of the present embodiment.

In the secondary battery 30 of the present embodiment, the negative terminal portion 15 includes: the plate-like negative external terminal 4 formed with the pin insertion hole 4b; the insulating member 3 formed with the pin insertion hole 3d and electrically isolating the battery lid 1 and the negative external terminal 4 from each other; and the connection pin 5 electrically connected to the negative plate constituting the power generating element group 11 and inserted through, in the following order, the pin insertion holes 1c, 3d and 4b formed in the battery lid 1, the insulating member 3 and the negative external terminal 4, respectively. The battery lid 1 is formed with the tubular projection 1a projecting toward the insulating member 3. The cylindrical projection 1a is secured to the insulating member 3 (see the caulking portion 1A in FIG. 2) by caulking so as to be bent outwardly inside the projection insertion hole 3b formed in the insulating member 3. The tip portion of the connection pin 5 inserted through the pin insertion holes 1c, 3d, 4b is caulked (see the caulking portion 5d in FIG. 2). This provides the structure in which conduction is established between the connection pin 5 and the negative external terminal 4 and the negative external terminal 4, the insulating member 3, the gasket 2 and the connection pin 5 are secured to the battery lid 1. (The same holds true for the positive terminal portion 16.)

According to the secondary battery 30 of the present embodiment, the battery lid 1 has the cylindrical projection 1a projecting therefrom. The cylindrical projection 1a is caulked with and secured to the insulating member 3 (the caulking portion 1A) at a position inside the projection insertion hole 3b formed at the other side end portion away from the pin insertion hole 3d of the insulating member 3. Therefore, when the tip portion of the connection pin 5 is caulked, the other side eng portion of the insulating member 3 will not loosen. Since the cylindrical projection 1a is caulked at the caulking portion 1A of the insulating member 3, the rotation center of rotary torque resulting from nut-fastening is the caulking portion 1A of the insulating member 3. The fitting portion between the circular projection 1b for preventing the turning of the battery lid 1 and the concave portion 3c of the insulating member 3 serves as a turn-stopper. No external force is applied to the seal portion between the connection pin 5 and the gasket 2, which prevents a decrease in seal performance. In this way, it is possible to dramatically prevent the fact that when the connection pin 5 is caulked, as in the conventional technology, the other side end portion spaced apart from the caulking portion of the insulating member 3 loosens, so that the terminal portions 15, 16 are each turned around the caulking portion. Therefore, it is possible to eliminate a decrease in the seal performance of the gasket 5 and an adverse effect (damage) of the positive and negative plates constituting the power generating element group 6 inside the battery on the collector. Thus, the highly-reliable secondary battery can be provided.

In the secondary battery 30 of the present embodiment, the square head bolt 6 and the insulating member 3 have a square fitting structure. Therefore, it is possible to prevent the square bolt 6 and the insulating member 3 from idle-turning. Further, the negative external terminal 4 has the constricted portion 4e formed between the circular section 4a and the rectangular section 4c. Therefore, when a nut is fastened to attach a bus bar to the square head bolt 6 for example, even if the vertical force F (see FIG. 3) is applied to the negative external terminal 4, deformation occurs in the constricted portion 4e of the negative external terminal 4. Thus, the vertical force F has no influence on the seal portion of the gasket 2, which can prevent a decrease in seal performance.

Further, the secondary battery 30 of the present embodiment has the plurality of (two in the embodiment) circular projections 1b and concave portions 3c fitted thereto. In addition, the circular projections 1b are fitted to the concave portions 3c at the respective positions apart from the imaginary straight line connecting the center of the pin insertion hole 1c with the center of the cylindrical projection 1a. Thus, the firmer and more reliable turn-prevention function can be achieved.

The secondary battery 30 of the present embodiment has the insulating protective portion 3a of the insulating member 3 formed to cover the outer circumference of the negative external terminal 4. This can improve the prevention of the idle-turn of the negative external terminal 4 and the withstand voltage performance of the battery lid 1 and the negative external terminal 4.

The present invention exemplifies the square lithium ion secondary battery; however, the present invention is not limited to this. The invention can be applied to e.g. a columnar secondary battery. The present embodiment exemplifies the power generating element group with a flat winding structure; however, the present invention is not limited to this. The present invention can be applied to a power generating element group with a not-flattened, columnar winding structure or to a power generating element group with a stacked structure in which positive and negative electrodes are arranged in a stacked manner via a separator.

The present embodiment exemplifies the battery can 20 and the battery lid 1 which are made of an aluminum alloy; however, the present invention is not limited to this. The present invention may use a battery can and a battery lid which are made of metal such as aluminum, nickel, steel or stainless steel, or resin. The material for the battery can 20 and the battery lid 1 is not particularly restrictive.

Further, the present embodiment exemplifies the projection insertion hole 3b (the through-hole) of the insulating member 3 as an object caulking the cylindrical projection 1a; however, the present invention is not limited to this. The invention may use a dent. The present embodiment exemplifies the cylindrical projection 1a having the cylindrical tip portion; however, the present invention is not limited to this. The invention may use a polygonal tubular projection. Further, also the circular projection 1b is not limited to a circular one. The present invention may use a polygonal projection.

The present embodiment shows the example in which the square head of the square head bolt 6 is received in the head receiving space; however, the present invention is not limited to this. Since the head needs only to be secured to the head receiving space without turning, the head needs only to be shaped into polygon. Further, a nut may be designed to be received in the receiving space in place of the head of the square head bolt 6. Even in such an embodiment, the bus bar is secured to the nut by means of a bolt.

### INDUSTRIAL APPLICABILITY

The present invention provides a highly-reliable secondary battery, which contributes to the manufacture and sale of the secondary battery. Thus, the present invention has industrial applicability.

1. A secondary battery comprising:
a closed-bottom metallic battery can for housing a power generating element;
a metallic battery lid for sealing an opening of the battery can, the battery lid being formed with a through-hole for leading out a terminal; and
a terminal portion installed on the battery lid, the terminal portion including a plate-like external terminal formed with a through-hole, an insulating member for electrically insulating the battery lid and the external terminal from each other, the insulating member being formed with a through-hole, and a pin-like conductive member electrically connected to an electrode plate constituting the power generating element, the conductive member being inserted through, in the following order, respective through-holes formed in the battery lid, the insulating member and the external terminal;
wherein the battery lid is formed with a first projection projecting toward the insulating member, with the first projection being fixed to a concave portion or a hole portion by caulking, the concave portion or the hole portion being formed in the insulating member in association with the position where the first projection is formed; and
wherein a tip portion of the conductive member inserted through the through-hole is caulked to establish conduction between the conductive member and the external terminal and to secure the external terminal, the insulating member and the conductive member to the battery lid.

2. The secondary battery according to claim 1,
wherein the tip portion of the first projection has a cylindrical or polygonal-tubular shape, and is secured to the insulating member by caulking so as to be bent outwardly at the concave portion or the hole portion formed in the insulating member.

3. The secondary battery according to claim 1,
wherein the battery lid is formed with a second projection projecting toward the insulating member at a position between the through-hole and the first projection, with the second projection being fitted to a concave portion or a hole portion formed, the concave portion or the hole portion being formed in the insulating member in association with the position where the second projection is formed.

4. The secondary battery according to claim 3,
wherein the battery lid is formed with a plurality of the second projections and the insulating member is formed with concave portions or hole portions, each portions corresponding to the positions of the respective second projections.

5. The secondary battery according to claim 3,
wherein the second projection is formed at a position apart from an imaginary line connecting the center of the through-hole and the center of the first projection, with the through-hole and the first projection being formed in and at the battery lid.

6. The secondary battery according to claim 1,
wherein the external terminal has a constricted portion reduced in width in a width direction.

7. The secondary battery according to claim 1,
wherein the terminal portion has an insulating seal member for sealing a gap defined between the battery lid and the conductive member at the through-hole formed in the battery lid.

8. The secondary battery according to claim 4,
wherein the second projection is formed at a position apart from an imaginary line connecting the center of the through-hole and the center of the first projection, with the through-hole and the first projection being formed in and at the battery lid.
